(19) United States
(12) Patent Application Publication
(10) Pub. No.: US 2013/0103583 A1
(43) Pub. Date: Apr. 25, 2013

(54) Universal Cash Account

(71) Applicants: James G. Ronca, Decatur, GA (US); David T. Frew, Fort Mill, SC (US); Tony England, Tega Cay, SC (US); Lisa Gibson, Newman, GA (US); Christopher R. Griggs, Fort Mill, SC (US)

(72) Inventors: James G. Ronca, Decatur, GA (US); David T. Frew, Fort Mill, SC (US); Tony England, Tega Cay, SC (US); Lisa Gibson, Newman, GA (US); Christopher R. Griggs, Fort Mill, SC (US)

(73) Assignee: BANK OF AMERICA CORPORATION, Charlotte, NC (US)

(21) Appl. No.: 13/280,533

(22) Filed: Oct. 25, 2011

(51) Int. Cl. G06Q 20/40

(52) U.S. Cl. 705/44

(57) ABSTRACT

According to one embodiment, an apparatus may include a memory and a processor. The memory may be operable to store a cash account associated with a cash value and a user. The processor may be operable to receive a request from the user to pay an amount from the cash account. The processor may determine, in response to the request, whether the amount exceeds the cash value associated with the cash account. The processor may then decrease the cash value associated with the cash account by the amount if the amount does not exceed the cash value of the cash account. The processor may then send a notification that includes the decreased cash value associated with the cash account. The apparatus may be associated with an enterprise and the enterprise may exclusively process the request.

### TECHNICAL FIELD

This disclosure relates generally to cashless transactions and, more specifically, to universal cash accounts.

### BACKGROUND

When conducting financial transactions, customers may pay for the transaction using any suitable payment mode, such as a checking account, a credit card account, a debit account, or other financial account. In order to use the various types of financial accounts, the customer has to be associated with various financial enterprises associated with each account.

### SUMMARY OF THE DISCLOSURE

In accordance with the present disclosure, the disadvantages and problems associated with prior payment methods have been substantially reduced or eliminated.

According to one embodiment, an apparatus may include a memory and a processor. The memory may be operable to store a cash account associated with a cash value and a user. The processor may be operable to receive a request from the user to pay an amount from the cash account. The processor may determine, in response to the request, whether the amount exceeds the cash value associated with the cash account. The processor may then decrease the cash value associated with the cash account by the amount if the amount does not exceed the cash value of the cash account. The processor may then send a notification that includes the decreased cash value associated with the cash account. The apparatus may be associated with an enterprise and the enterprise may exclusively process the request.

Certain embodiments may provide one or more technical advantages. A technical advantage of one embodiment includes lessening dependence on cash. Another technical advantage of one embodiment includes providing a cashless transaction method for consumers who are otherwise not associated with a financial enterprise. Certain embodiments of the invention may include none, some, or all of the above technical advantages. One or more other technical advantages may be readily apparent to one skilled in the art from the figures, descriptions, and claims included herein.

### BRIEF DESCRIPTION OF THE FIGURES

For a more complete understanding of the present invention and its features and advantages, reference is now made to the following description, taken in conjunction with the accompanying drawings, in which:

FIG. 1 illustrates a system for using a universal cash account;

FIG. 2 illustrates a server of the system of FIG. 1 storing a universal cash account;

FIG. 3 is a flowchart illustrating a method of creating a universal cash account and adding funds to a universal cash account using the system of FIG. 1; and

FIG. 4 is a flowchart illustrating a method of payment using the system of FIG. 1.

### DETAILED DESCRIPTION OF THE FIGURES

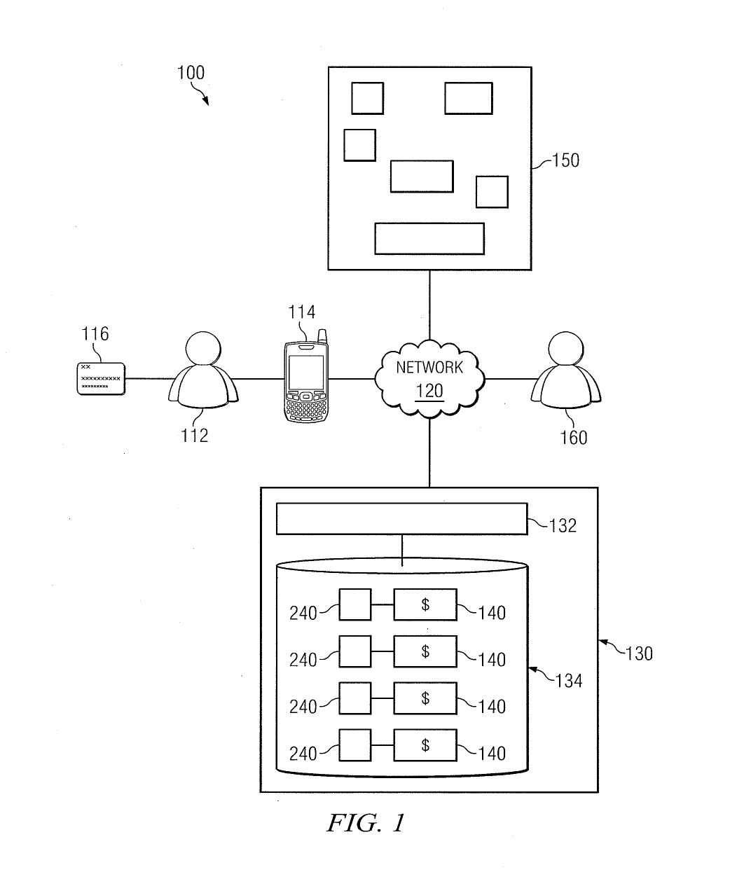

Embodiments of the present invention and its advantages are best understood by referring to FIGS. 1 through 4 of the drawings, like numerals being used for like and corresponding parts of the various drawings.

FIG. 1 illustrates a system 100 for using a universal cash account 240. As provided by FIG. 1, system 100 may include a mobile device 114, a network 120, a kiosk 150, and a server 130. In general, user 112 may be associated with a universal cash account 240 stored in server 130. User 112 may access cash account 240 by using a card 116. User 112 may then use cash account 240 to pay a second user such as, for example, a merchant 160. Merchant 160 may redeem the amount of cash by accessing server 130.

System 100 may include mobile device 114. As an example and not by way of limitation, mobile device 114 may be a laptop, a wireless or cellular telephone, an electronic notebook, a personal digital assistant, or any other device capable of receiving, processing, storing, and/or communicating information with other components of system 100. Mobile device 114 may also include a user interface, such as a display, a microphone, keypad, or other appropriate terminal equipment usable by a user 111. Mobile device 114 may be associated with a user 112 such as, for example, an owner of mobile device 114. In general, user 112 may use mobile device 114 to conduct a transaction. Mobile device 114 may execute an application stored on memory 134 to perform the functions described herein. In particular embodiments, user 112 may use mobile device 114 to determine the value of cash value 140 associated with user 112. In this manner, user 112 may track a sum of “electronic cash” on mobile device 114. User 112 may also provide mobile device 114 to merchant 160 to facilitate payment for a good or service. In this manner, user 112 may use mobile device 114 as a means for paying for goods and services.

System 100 may include network 120. Mobile device 114 may communicate with server 130 and kiosk 150 through network 120. This disclosure contemplates any suitable network 120 operable to facilitate communication between the components of system 100, such as mobile device 114 and server 130. Network 120 may include any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

System 100 may further include a kiosk 150. User 112 may use kiosk 150 to add funds to cash account 240 of the user 112. As an example and not by way of limitation, user 112 may provide authentication information to kiosk 150 to identify user 112 and/or mobile device 114. After completing the authentication process, user 112 may indicate an amount of money to be added to cash account 240. As a result, kiosk 150 may generate a request to add the amount to cash account 240, and send the request to server 130. Server 130 may then increase cash value 140 associated with cash account 240 by the amount indicated by user 112. User 112 may provide funds to kiosk 150 to increase cash value 140. Kiosk 150 may also transfer funds from a second account to increase cash value 140. Although this disclosure describes kiosk 150 enabling user 112 to perform particular actions, this disclosure contemplates kiosk 150 enabling user 112 to perform any suitable actions, such as for example, creating cash account 240, managing cash account 240, viewing details of cash account 240, and redeeming funds from cash account 240. In particular embodiments, kiosk 150 may be an automatic teller machine. Although this disclosure describes adding funds to cash account 240 in a particular manner, this disclosure contemplates adding funds to cash account 240 in any suitable manner. For example, user 112 may add funds to cash account 240 through a webpage on the Internet. As another example, user 112 may add funds to cash account 240 by electronically transferring funds from another account of the user 112, such as a checking account. In particular embodiments, after increasing cash value 140, server 130 may send a notification, such as for example a text message, to inform user 112 of the increased cash value 140.

In particular embodiments, user 112 may be associated with a card 116. User 112 may present card 116 to merchant 160 or swipe card 116 to request a transaction. For example, after merchant 160 swipes card 116, merchant 160 may indicate an amount to be subtracted from cash value 140. A request to access the associated cash account 240 may then be generated and sent to server 130. In response, server 130 may decrease the value of cash value 140 associated with cash account 240 by the amount and add the same amount to an account of the merchant 160. That amount may then be transferred from cash account 240 to an account of the merchant 160.

System 100 may include server 130. In general, server 130 may facilitate the use of cash account 240 by user 112 to conduct transactions with merchant 160. In particular embodiments, mobile device 114, server 130, or the combination of the two may facilitate the use of cash account 240 to conduct transactions with merchant 160. As an example and not by way of limitation, server 130 may increase and decrease a cash value 140 associated with cash account 240 based on the transactions made by user 112, and send updated cash values 140 to mobile device 114 through network 120. As another example and not by way of limitation, server 130 may facilitate the redemption of funds by merchant 160. Server 130 may be associated with an enterprise, such as for example, a corporation or a bank. In particular embodiments, transactions involving cash account 240 may be processed exclusively by the enterprise.

Server 130 may include processor 132. Processor 132 may control the operation and administration of server 130 by processing information received from network 120 and memory 134. Processor 132 may include any hardware and/or software that operates to control and process information. For example, processor 132 may compare cash value 140 against the cost of a good or service. Processor 132 may also increase or decrease the value of cash value 140, and send updated cash values 140 to mobile device 114. Processor 132 may be a programmable logic device, a microcontroller, a microprocessor, any suitable processing device, or any suitable combination of the preceding. This disclosure contemplates processor 132 performing any of the actions described herein.

Processor 132 may be coupled to a memory 134. Memory 134 may store, either permanently or temporarily, data, operational software, or other information. Memory 134 may include any one or a combination of volatile or non-volatile local or remote devices suitable for storing information. For example, memory 134 may include random access memory (RAM), read only memory (ROM), magnetic storage devices, optical storage devices, or any other suitable information storage device or a combination of these devices. In particular embodiments, memory 134 of server 130 may store cash accounts 240. Memory 134 of server 130 may further store a cash value 140 associated with each cash account 240.

Server 130 may further process transaction requests in bundles. As an example and not by way of limitation, merchant 160 may receive multiple transactions requests from a user 112 or multiple users 112. Merchant 160 may generate a bundle of requests that includes the requests from user(s) 112. The bundle may further include requests of merchant 160. Merchant 160 may then send the bundle to server 130 for processing. In this manner, merchant 160 may save on bandwidth costs and processing fees.

In particular embodiments, server 130 may be associated with an enterprise that directly handles the transactions between user 112 and merchant 160. As an example and not by way of limitation, when user 112 pays for a good or service from merchant 160, such as by swiping card 116, a request may be generated and sent directly to server 130. Server 130 may then process the request by deducting the cost of the good or service from a cash value 140 associated with a cash account 240 of user 112, and by adding the cost to an account of merchant 160. Server 130 may then send an updated cash value 140 to mobile device 114. Mobile device 114 may then update cash value 140 stored in the memory of mobile device 114. In this manner, user 112 may quickly conduct transactions with merchant 160 because the enterprise may handle the transaction internally. The enterprise may maintain and update the cash value 140 associated with user 112 as the user 112 conducts transactions.

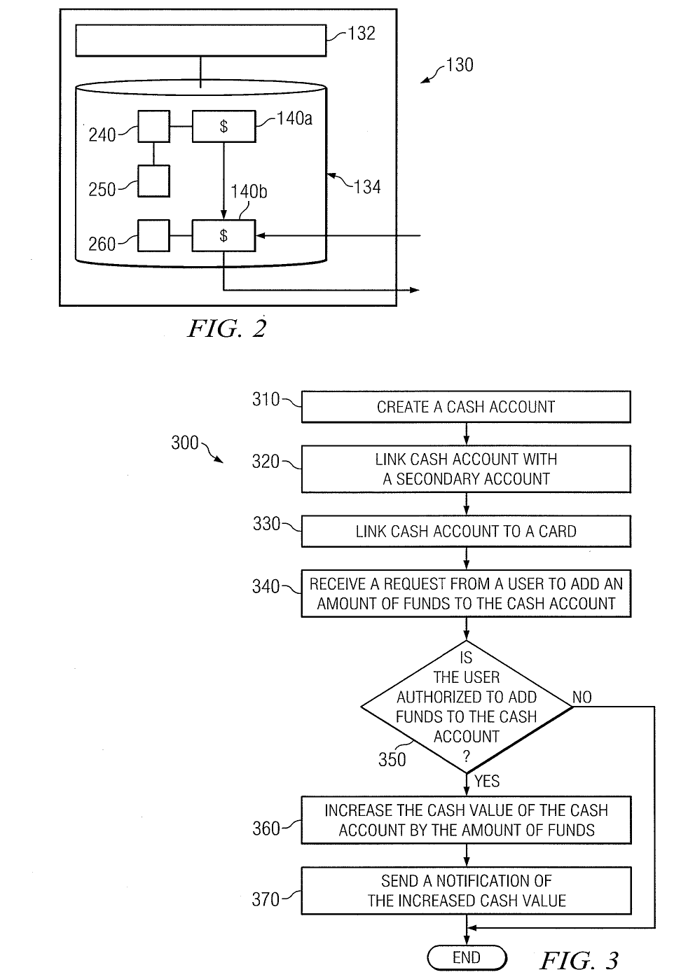

User 112 may be associated with a particular cash account 240. In particular embodiments, when user 112 uses card 116 or mobile device 114 to perform a transaction with merchant 160, server 130 may update and store the cash value 140 associated with cash account 240. The process by which server 130 tracks and stores the results of transactions by user 112 will be discussed further with respect to FIGS. 2 through 4.

In operation, server 130 may be used to facilitate user 112 using mobile device 114 to pay for goods and services. When user 112 communicates with kiosk 150, kiosk 150 may communicate with server 130 to create cash account 240, associate a user ID and password with cash account 240, and associate cash value 140 with cash account 240. Although this disclosure describes user 112 creating cash account 240 in a particular manner, this disclosure contemplates user 112 creating cash account 240 in any suitable manner, such as for example, through a website or through mobile device 114.

When user 112 adds funds to cash account 240, server 130 may receive a request to add funds. In response, server 130 may increase cash value 140 associated with cash account 240 by the amount of funds added. In particular embodiments, server 130 may send updated cash values 140 to mobile device 114. Mobile device 114 may then store these cash values 140 in a memory of mobile device 114. User 112 may check mobile device 114 to determine the value of cash value 140 associated with user 112. In particular embodiments, server 130 may also send notifications, such as for example, text messages, to mobile device 114 to inform user 112 of an updated cash value 140.

When user 112 purchases a good or service from merchant 160, the merchant 160 may send a request to server 130 instructing the server 130 to transfer the price of the good or service from cash account 240 of the user 112 to an account of the merchant 160. In response, server 130 may deduct the price of the good or service from the cash value 140 associated with the cash account 240 of the user 112, and add an amount to an account of the merchant 160.

As an example and not by way of limitation, a user 112 approaches kiosk 150 to create a cash account 240. The user associates an identifier and a password with cash account 240. User 112 then adds a particular amount, such as $5, to cash account 240 at kiosk 150. Later, user 112 attempts to purchase a product from merchant 160. In this example, user 112 does not have cash, and the product costs $2.50. When user 112 approaches merchant 160, user 112 may present mobile device 114 or a card 116, each associated with cash account 240, to complete the transaction. Merchant 160 may then use card 116 or mobile device 114 to generate a request to server 130 to process the transaction. When server 130 receives the transaction, server 130 may access cash account 240, subtract $2.50 from cash value 140, and add $2.50 to an account associated with merchant 160. In this manner, user 112 purchases the product from merchant 160 without using cash, while merchant 160 experiences the same benefits of conducting a cash transaction by quickly receiving the money in the account of merchant 160.

In particular embodiments, system 100 may lessen dependence on cash. As an example and not by way of limitation, rather than carry a large sum of money, user 112 may carry mobile device 114 or card 116. User 112 may then use mobile device 114 or card 116 to conduct transactions rather than using cash. When user 112 conducts a transaction with merchant 160, user 112 may present mobile device 114 or card 116 to complete the transaction. Server 130 may then receive and process the transaction by updating the cash value 140 of cash account 240 associated with user 112 and by directly updating an account of merchant 160. In this manner, an account of the merchant 160 may be quickly updated, and merchant 160 may quickly redeem cash from the account. Furthermore, user 112 may use cash account 240 without having another financial account, such as for example a savings account, a checking account, a credit card account, a line of credit account, or any other suitable financial account. In this manner, user 112 may have access to cash account 240 even though user 112 is not a client of a bank or other financial institution. In particular embodiments, because server 130 may be associated with an enterprise that exclusively processes the transactions between user 112 and merchant 160, the transactions may be viewed “as good as cash” even though physical cash does not exchange hands. Furthermore, because the transactions may be viewed “as good as cash,” networks that are used to process debit, credit, ACH, or any similar type transactions may not be needed to process transactions involving cash account 240.

FIG. 2 illustrates a server 130 of the system 100 of FIG. 1 storing a universal cash account 240. In general, server 130 may store information that facilitates transactions involving cash account 240, such as for example, cash value 140a and secondary account 250. Server 130 may facilitate payments that are “as good as cash,” even though physical cash does not exchange hands, by quickly subtracting amounts from cash account 240, quickly adding amounts to merchant account 260, and quickly processing any redemptions from merchant account 260.

In particular embodiments, server 130 may store cash account 240 in memory 134. Cash account 240 may be associated with user 112, mobile device 114, and/or card 116. As an example and not by way of limitation, cash account 240 may include a user ID and password associated with user 112, an Internet Protocol address and/or Media Access Control address associated with mobile device 114, and a card number associated with card 116. Although this disclosure describes cash account 240 including particular types of information, this disclosure contemplates cash account 240 including any suitable information to associate cash account 240 to user 112, mobile device 114, and/or card 116.

Cash account 240 may further be associated with a cash value 140a. Cash value 140a may represent an amount of money associated with cash account 240. Cash value 140a may be increased or decreased based on the actions of user 112 associated with cash account 240. Cash value 140a may increase when user 112 adds funds to cash account 240, for example through kiosk 150. Cash value 140a may decrease when user 112 purchases a good or service from merchant 160 using cash account 240. When a user 112 performs a transaction using cash account 240, payments to or from cash account 240 may be treated as a cash transaction. That is, increases and decreases to the value of cash value 140a may substitute for an exchange of cash. As an example and not by way of limitation, when user 112 attempts to make a cash purchase from merchant 160, instead of giving cash to merchant 160, the amount of the purchase from cash account 240 is transferred to a cash account of merchant 160. As another example and not by way of limitation, when user 112 provides cash to kiosk 150 to be associated with cash account 240, cash value 140a increases by the amount of cash provided.

In particular embodiments, cash account 240 may be associated with a secondary account 250. Secondary account 250 may also be associated with user 112 and/or mobile device 114. As an example and not by way of limitation, secondary account 250 may be a checking account associated with user 112, a phone account associated with mobile device 114, or any other suitable account associated with user 112 and/or mobile device 114. In particular embodiments, secondary account 250 represents an account that server 130 may access if cash account 240 does not have the necessary cash value 140 to complete a transaction. As an example and not by way of limitation, if user 112 attempts to purchase a good or service that costs more than the value of cash value 140a, the difference may be paid from or charged to secondary account 250. As an example and not by way of limitation, if secondary account 250 is a phone account associated with mobile device 114, the amount by which the price of a good exceeds the value of cash value 140a may be charged to the phone account. When user 112 receives the monthly phone bill, user 112 may see the overcharge amount as part of the bill.

In particular embodiments, memory 134 of server 130 may store a merchant account 260. Merchant account 260 may be a cash account associated with merchant 160. As an example and not by way of limitation, merchant account 260 may include identification information of the merchant 160 such as, for example, an identifier and password associated with merchant 160. Merchant account 260 may be associated with a cash value 140b. Cash value 140b may represent an amount of cash associated with merchant account 260. In particular embodiments, cash value 140b may increase or decrease through payments and/or redemptions. As an example and not by way of limitation, when user 112 associated with cash account 240 makes a purchase from merchant 160 associated with merchant account 260, the price of the purchase may be transferred from cash value 140a to cash value 140b. Cash value 140a may decrease by the price of the purchase and cash value 140b may increase by the price of the purchase. Although this disclosure describes cash value 140b increasing through a particular transaction, this disclosure contemplates cash value 140b increasing from any suitable transaction. For example, cash value 140b may increase from a transfer from an account external to memory 134 such as a checking account, a savings account, a phone account, or any suitable account. Cash value 140b may also increase through kiosk 150 using the process described above with respect to FIG. 1.

In particular embodiments, merchant 160 may make redemptions against merchant account 260. Merchant 160 may send server 130 a request to redeem a particular amount of money from merchant account 260. In response, server 130 may determine whether the particular amount exceeds cash value 140b. If the particular amount exceeds the cash value 140b, server 130 may reject the redemption request. If the particular amount does not exceed cash value 140b, then the value of cash value 140b may be decreased by the particular amount. Server 130 may then send a notification to the enterprise associated with server 130, and the enterprise may send merchant 160 the particular amount of cash. In particular embodiments, server 130 may send a notification to merchant 160 indicating the decreased cash value 140b. In this manner, cash value 140b may be “as good as cash” because merchant 160 may quickly redeem cash value 140b as cash because the enterprise is the only entity who receives and processes the redemption request.

FIG. 3 is a flowchart illustrating a method 300 of creating a universal cash account 240 and adding funds to a universal cash account 240 using the system 100 of FIG. 1. Method 300 may be performed by any suitable component of system 100 such as, for example, server 130. In particular embodiments, server 130 may begin by creating a cash account 240 in step 310. Cash account 240 may be associated with a cash value 140. Additionally, cash account 240 may be stored within a memory 134 of server 130. Server 130 may link the cash account 240 with a secondary account 250 in step 320. In particular embodiments, the secondary account 250 may act as an overcharge account. Server 130 may link the cash account 240 to a card 116 in step 330. Card 116 may be swiped to generate a request to pay an amount of cash from cash account 240. By following steps 310 through 330, server 130 may create and set up cash account 240 to facilitate payments.

Server 130 may receive a request from a user 112 to add an amount of funds to the cash account 240 in step 340. The user 112 may have generated the request at a kiosk 150. In step 350, server 130 may determine if the user 112 is authorized to add cash to the cash account 240. As an example and not by way of limitation, server 130 may authenticate user 112 through a user ID and password prior to adding cash to the cash account 240. If the user 112 is not authorized to add cash to the cash account 240, server 130 may conclude. If the user 112 is authorized to add cash to the cash account 240, server 130 may continue by increasing the cash value 140 of the cash account 240 by the amount of cash in step 360. Server 130 may then conclude by sending a notification that informs of the increased value in step 370. The notification may be sent to another component of system 100 such as, for example, mobile device 114, to communicate to that component that the cash value 140 of the cash account 240 has been increased. In particular embodiments, the notification may take the form of a text message to inform user 112 that the cash value 140 of cash account 240 has been increased.

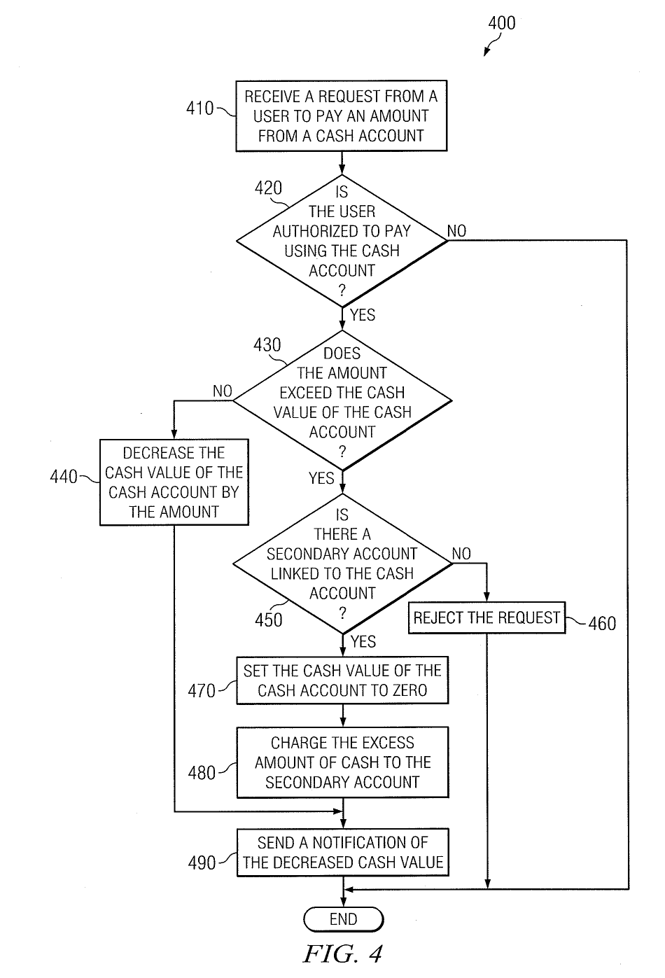

FIG. 4 is a flowchart illustrating a method 400 of payment using the system 100 of FIG. 1. Method 400 may be performed by any suitable component of system 100 such as, for example, server 130. In particular embodiments, server 130 may receive a request from a user 112 to pay an amount from a cash account 240 in step 410. Server 130 may continue by determining if the user 112 is authorized to pay using the cash account 240 in step 420. If the user 112 is not authorized to use the cash account 240, server 130 may conclude. As an example and not by way of limitation, server 130 may determine if the user 112 is authorized to use the cash account 240 by authenticating the user 112 using a user ID and password associated with user 112. If server 130 determines that the user 112 is authorized to use the cash account 240, server 130 may then determine if the amount exceeds the cash value of the cash account in step 430. If the amount does not exceed the cash value of the cash account, server 130 may continue to step 440 by decreasing the cash value of the cash account 240 by the amount. Server 130 may then conclude by sending a notification of the decreased cash value 140 in step 490. In particular embodiments, the notification may be sent to a mobile device 114 of the user 112.

If the amount exceeds the cash value 140 of the cash account 240, server 130 may determine whether there is a secondary account 250 linked to the cash account 240 in step 450. In particular embodiments, the secondary account 250 may be an account associated with the mobile device 114 of the user 112. If there is no secondary account 450 linked to the cash account 240, then server 130 may conclude by rejecting the transaction in step 460. If there is a secondary account 250 linked to the cash account 240, server 130 may continue to step 470 by setting the cash value 140 of the cash account 240 to zero, and in step 480, server 130 may charge the excess amount to the secondary account 250. In particular embodiments, server 130 may calculate the excess amount by calculating the difference between the amount and the cash value 140. Server 130 may then conclude by sending a notification of the decreased cash value in step 490. The notification may facilitate the payment of the excess amount by the secondary account 250.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. A method, comprising:
storing, by a memory, a cash account, the cash account associated with a cash value and a user;
receiving, by a processor communicatively coupled to the memory, a request from the user to pay an amount from the cash account;
determining, by the processor, in response to the request, whether the amount exceeds the cash value associated with the cash account;
decreasing, by the processor, the cash value associated with the cash account by the amount if the amount does not exceed the cash value of the cash account; and
sending, by the processor, a notification comprising the decreased cash value associated with the cash account, wherein the processor is associated with an enterprise and the enterprise exclusively processes the request.

2. The method of claim 1, further comprising:
determining, by the processor, that the cash account is associated with a secondary account if the amount does exceed the cash value associated with the cash account;
calculating, by the processor, the difference between the amount and the cash value associated with the cash account;
decreasing, by the processor, the cash value of the cash account to zero; and
accessing, by the processor, the secondary account to facilitate payment of the difference.

3. The method of claim 2, wherein the secondary account is associated with a mobile device of the user.

4. The method of claim 1, wherein the notification is sent to a mobile device of the user.

5. The method of claim 1, further comprising:
receiving, by the processor, a second request to add a second amount to the cash account;
determining, by the processor, in response to the second request, that the user is authorized to add cash to the cash account;
increasing, by the processor, the cash value associated with the cash account by the second amount; and
sending, by the processor, a second notification comprising the increased cash value associated with the cash account.

6. The method of claim 1, further comprising:
determining, by the processor, that the cash account is not associated with a secondary account if the amount does exceed the cash value associated with the cash account; and
rejecting, by the processor, the request.

7. The method of claim 1, wherein the request is generated by swiping a card associated with the cash account.

8. The method of claim 1, further comprising:
storing, by the memory, a second cash account associated with a second cash value;
receiving, by the processor, a second request to redeem a second amount of cash from the second cash account;
determining, by the processor, in response to the second request, that the second amount is less than or equal to the second cash value;
decreasing, by the processor, the second cash value by the second amount; and
sending, by the processor, a notification to facilitate the processing of the second request to redeem.

9. The method of claim 8, further comprising:
generating, by the processor, a bundle of requests comprising the request and the second request; and
processing, by the processor, the bundle of requests.

10. The method of claim 8, wherein the second cash account is associated with a merchant, and wherein processing the second request results in the merchant receiving cash.

11. An apparatus, comprising:
a memory operable to store a cash account, the cash account associated with a cash value and a user;
a processor operable to:
receive a request from the user to pay an amount from the cash account;
determine, in response to the request, whether the amount exceeds the cash value associated with the cash account;
decrease the cash value associated with the cash account by the amount if the amount does not exceed the cash value of the cash account; and
send a notification comprising the decreased cash value associated with the cash account, wherein the processor is associated with an enterprise and the enterprise exclusively processes the request.

12. The apparatus of claim 11, the processor further operable to:
determine that the cash account is associated with a secondary account if the amount does exceed the cash value associated with the cash account;
calculate the difference between the amount and the cash value associated with the cash account;
decrease the cash value of the cash account to zero; and
access the secondary account to facilitate payment of the difference.

13. The apparatus of claim 12, wherein the secondary account is associated with a mobile device of the user.

14. The apparatus of claim 11, wherein the notification is sent to a mobile device of the user.

15. The apparatus of claim 11, the processor further operable to:
receive a second request to add a second amount to the cash account;
determine in response to the second request, that the user is authorized to add cash to the cash account;
increase the cash value associated with the cash account by the second amount; and
send a second notification comprising the increased cash value associated with the cash account.

16. The apparatus of claim 11, the processor further operable to:
determine that the cash account is not associated with a secondary account if the amount does exceed the cash value associated with the cash account; and
reject the request.

17. The apparatus of claim 11, wherein the request is generated by swiping a card associated with the cash account.

18. The apparatus of claim 11,
the memory further operable to store a second cash account associated with a second cash value; and
the processor further operable to:
receive a second request to redeem a second amount of cash from the second cash account;
determine in response to the second request, that the second amount is less than or equal to the second cash value;
decrease the second cash value by the second amount; and
send a notification to facilitate the processing of the second request to redeem.

19. The apparatus of claim 18, the processor further operable to:
generate a bundle of requests comprising the request and the second request; and
process the bundle of requests.

20. The apparatus of claim 18, wherein the second cash account is associated with a merchant, and wherein processing the second request results in the merchant receiving cash.
